(19) United States
(12) Patent Application Publication
(10) Pub. No.: US 2002/0107350 A1
(43) Pub. Date: Aug. 8, 2002

(54) Polymerizable monomer compositions, transparent polymer substrates, and optical and ophthalmic articles obtained

(75) Inventors: Gilles Widawski, Paris (FR); Jean-Paul Cano, Chennevieres Sur Marne (FR); Jean-Francois Magne, Av Bergen (NL)

Correspondence Address: Robert M. O'Keefe, O'KEEFE, EGAN & PETERMAN, Building C, Suite 200, 1101 Capital of Texas Highway South, Austin, TX, 78746, US

(73) Assignee: Essilor International Compagnie Generale D'Optique

(21) Appl. No.: 09/996,282

(22) Filed: Nov. 28, 2001

Related U.S. Application Data
(63) Continuation of application No. 09/254,503, filed on Mar. 5, 1999, now abandoned.
Application No. 09/254,503 is a 371 of international application No. PCT/FR98/01421, filed on Jul. 3, 1998.

(30) Foreign Application Priority Data
Jul. 7, 1997 (FR) 97 08614
Jul. 30, 1997 (FR) 97 09733

(51) Int. Cl. C08F 20/68

(52) U.S. Cl. 526/318.4; 526/318; 526/321; 526/329.7

(57) ABSTRACT

Polymerizable monomer compositions, transparent polymer substrates and optical and ophthalmic articles obtained.

The compositions according to the invention comprise

30 to 100% of one or more monomers (I) of formula:

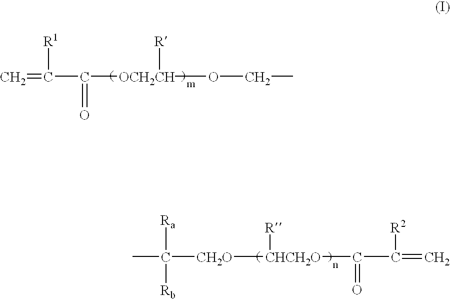

in which R¹, R², R′ and R″ represent, independently of one another, a hydrogen atom or a methyl radical, Rₐ and R_{b}, which are identical or different, each represent an alkyl group having 1 to 10 carbon atoms, provided that Rₐ and R_{b} do not simultaneously represent a methyl group, and m and n are integers satisfying the relationship 2≦m+n≦20;

0 to 70% of at least one other polymerizable monomer (II) comprising one or more (meth)acrylate functional groups, other than the monomer (I), such that a transparent substrate resulting from the polymerization of the composition has a glass transition temperature satisfying the relationship 70° C.≦Tg≦110°C.; and

at least one system for initiating the polymerization.

Application to the manufacture of optical and ophthalmic articles.

The present invention generally relates to polymerizable monomer compositions which, after polymerization, provide transparent polymerized substrates which are particularly suitable for the manufacture of optical and ophthalmic articles, such as lenses or glasses for spectacles.

More particularly, the present invention relates to such polymerizable monomer compositions which, after polymerization, result in transparent substrates with a refractive index with a value generally of less than 1.54, preferably of less than 1.52 and preferably close to 1.5, and with a low density.

The present invention also relates to the substrates obtained by polymerization of the polymerizable monomer compositions according to the invention and to the optical and ophthalmic articles obtained from these substrates.

The optical and ophthalmic articles must possess the combination of following characteristics:

a high transparency (transmission generally of greater than 85% and preferably of greater than or equal to 90%), with an absence [lacuna] or optionally a very low light scattering;

a high Abbe number of greater than or equal to 30 and preferably of greater than or equal to 35, in order to avoid chromatic aberrations;

a low yellowing index and an absence of yellowing over time;

a good impact strength and resistance to abrasion;

good suitability for various treatments (shock-proof primer, anti-glare or hard coating deposition, and the like) and in particular a good suitability for colouring;

good suitability for surface working and edging treatments, without the overall geometry of the glass being deformed during these operations.

In addition, the polymerizable compositions for the manufacture of optical and ophthalmic articles must also be easy to process industrially.

It is also desirable for the compositions to be able to be easily and quickly polymerized, in particular for them to be able to be polymerized by photopolymerization techniques or mixed photopolymeri- zation and thermal polymerization techniques, making it possible to reduce the cycle times for the manufacture of the articles.

It is also desirable for the polymerizable compositions to be able to be employed in overmoulding processes.

Finally, it is also desirable for the polymerizable compositions and the polymerized substrates obtained to be suitable for photo- chromatization, in order to obtain optical and ophthalmic articles possessing photochromic properties.

The object of the present invention is therefore to provide a polymerizable monomer composition which, after polymerization, results in transparent substrates which meet the above requirements.

Another subject-matter of the present invention is the transparent substrates, in particular substrates having photochromic properties, obtained by polymerization, by a thermal or photochemical route or by a combination of these two routes, of the compositions according to the invention.

Finally, another subject-matter of the present invention is optical and ophthalmic articles, in particular substrates having photochromic properties, such as lenses and glasses for spectacles, obtained from the above substrates.

According to the invention, the polymerizable monomer composition comprises, with respect to the total weight of the polymerizable monomers present in the composition:

30 to 100% of one or more monomers (I) of formula:

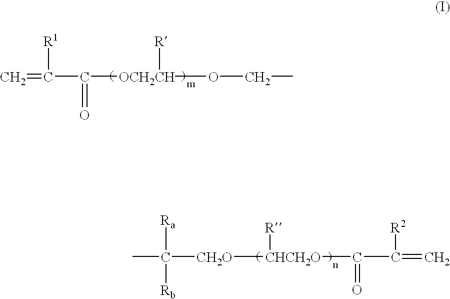

in which R¹, R², R′ and R″ represent, independently of one another, a hydrogen atom or a methyl radical, Rₐ and R_{b}, which are identical or different, each represent an alkyl group having 1 to 10 carbon atoms, provided that Rₐ and R_{b} do not simultaneously represent a methyl group, and m and n are integers satisfying the relationship 2≦m+n≦20;

0 to 70% of at least one other monomer (II) polymerizable by a radical route, other than the monomer (I), such that a transparent substrate resulting from the polymerization of the composition has a glass transition temperature satisfying the relationship 70° C.≦Tg≦110°C.; and

at least one system for initiating the polymerization.

The first important constituent of the polymerizable compositions according to the invention is the monomer or monomers (I) corresponding to the above formula.

Preferably, in the above formula of the monomers (I), R¹ and R² represent a methyl group and Rₐ and R_{b} represent an alkyl group having 2 to 10 carbon atoms. Preferably, Rₐ and R_{b} represent an ethyl, propyl or butyl radical. More preferably, Rₐ and R_{b} are different from one another and in particular Rₐ and R_{b} respectively represent an ethyl group and a butyl group (preferably n-butyl).

Preferably, m and n are integers such that 2≦m+n≦10 and better still 2≦m +n ≦5.

Mention may be made, among the monomers (I) particularly recommended in the compositions according to the invention, of 2,2-di(C₂-C₁₀)alkyl-1,3-propanediol 2x-propoxylate di(meth)acrylate and 2,2-di(C₂-C₁₀)alkyl-1,3-propanediol 2x-ethoxylate di(meth)acrylate.

As indicated above, the particularly recommended monomers (I) are dimethacrylates and very particularly the compound 2-ethyl-2-n-butyl-1,3-propanediol 2x-propoxylate dimethacrylate (EBP 2PO DMA).

(Meth)acrylic monomers (I) corresponding to the above formula and their process of preparation are disclosed in the document WO-95/11219. The monomers (I) of the compositions of the present invention can be prepared by the process disclosed in the cited document.

Briefly, these (meth)acrylic monomer [sic] (I) are prepared by at least two stages of alkoxylation and is of acrylation. Initially, the 2,2-dialkyl-6; 1,3-propanediol is alkoxylated by reaction with the corresponding alkylene oxide. The product resulting from the alkoxylation is finally esterified with acrylic and/or methacrylic acid, in order to obtain the desired (meth)acrylic monomer. It is also possible, instead of the direct esterification by (meth)acrylic acids, to use a transesterification reaction by using the corresponding (meth)acrylates. For further details as regards the process of preparation of the (meth)acrylic monomers (I), reference may be made to the document WO-95/11219.

The monomer or monomers (I) represent 30 to 100% by weight of the polymerizable monomers present in the compositions, preferably 30 to 70% by weight and better still from 40 to 70% by weight.

The second important constituent of the polymerizable compositions according to the invention, which can optionally be present in these compositions, is a monomer or a mixture of monomers (II), other than the monomers (I), polymerizable by a radical route. These polymerizable monomers (II) must be such that the transparent substrates resulting from the polymerization of the polymerizable compositions have a glass transition temperature which satisfies the relationship 70° C.[sic]≦Tg≦110° C., preferably 80° C.≦Tg≦100° C.

The polymerizable monomers (II) generally comprise one or more (meth)acrylate functional groups and/or one or more allyl groups.

Preferably, these monomers (II) comprise one, two or three (meth)acrylate functional groups, better still one or two (meth)acrylate functional groups or one or two allyl groups or alternatively one allyl group and one (meth)acrylate functional group. More preferably, the polymerizable monomers (II) comprise methacrylate functional groups, better still two methacrylate functional groups, two allyl groups or one allyl group and one (meth)acrylate functional group.

A first preferred class of the polymerizable monomers (II) comprises the monomers corresponding to the formula:

R³−O(R^{5σ)}ₚR⁴(IIa)

in which R³ is an acryloyl or methacryloyl radical, R⁴ is a hydrogen atom, an acryloyl radical, a methacryloyl radical or a hydrocarbon-comprising group having 1 to 40 carbon atoms, R⁵ is an alkylene group having 1 to 5 carbon atoms and p is an integer from 2 to 50.

Preferably, R³ and R⁴ represent methacryloyl groups and R⁵ is an ethylene, propylene or butylene group, better still an ethylene or propylene group.

Mention may be made, among the monomers of formula (IIa), of poly(methylene glycol) mono- and di(meth)acrylates, poly(ethylene glycol) mono- and di(meth)acrylates, poly(propylene glycol) mono- and di(meth)acrylates, alkoxypoly(methylene glycol) mono-and di(meth)acrylates [sic], alkoxypoly(ethylene glycol) mono- and di(meth)acrylates [sic] and poly(ethylene glycol)-poly(propylene glycol) mono- and di(meth)acrylates. These monomers are disclosed, inter alia, in the document U.S. Pat. No. 5,583,191.

A second class of monomers (II) suitable for the compositions of the present invention comprises the monomers corresponding to the formula:

R⁶-Y-R⁷ (IIb)

where R⁶ and R⁷ represent a hydrogen atom, an acryloyl group or a methacryloyl group, at least one of R⁶ or R⁷ being a (meth)acryloyl group, and Y is an alkylene radical having at least 10 carbon atoms. Preferably, R⁶ and R⁷ are methacryloyl groups and Y is an alkylene group having 2 to 50 carbon atoms.

A third class of monomers (II) suitable for the compositions according to the invention comprises the monomers corresponding to the formula:

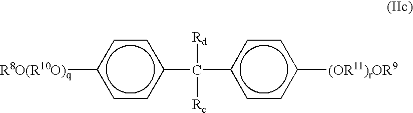

in which R⁸ and R⁹ represent a hydrogen atom, an acryloyl group or a methacryloyl group, provided that at least one of R⁸ or R⁹ is a (meth)acryloyl group, R_{d} and Rₑ represent H or CH₃, R¹⁰ and R¹¹ represent a C₁-C₅ alkylene group, and q and r are such that the mean value \overline{q+r}≧2.

Preferably, R⁸ and R⁹ are methacryloyl groups, R_{d} and Rₑ are methyl groups, R¹⁰ and R¹¹ are ethylene or propylene groups and 4≦\overline{q+r}≦50.

A fourth class of monomers (II) of use in the present invention comprises allyl monomers, preferably difunctional monomers, such as poly(alkylene glycol) di(allyl carbonate) [sic], and monomers comprising a (meth)acrylate functional group and an allyl group, in particular a methacrylate functional group and an allyl group.

Mention may be made, among the poly(alkylene glycol) di(allyl carbonate) [sic] suitable for the present invention, of ethylene glycol di(2-chloroallyl carbonate), di(ethylene glycol) di(allyl carbonate), tri(ethylene glycol) di(allyl carbonate), propylene glycol di(2-ethylallyl carbonate), di(propylene glycol) di(allyl carbonate), tri(methylene glycol) di(2-ethylallyl carbonate) and penta(methylene glycol) di(allyl carbonate).

The preferred di(allyl carbonate) is di(ethylene glycol) di(allyl carbonate), sold under the trade name CR-39 Allyl Diglycol Carbonate by the company PPG Industries Inc.

The preferred monomer comprising an allyl group and a methacrylic functional group is allyl methacrylate.

Mention may be made, among the particularly recommended monomers (II), of tri(propylene glycol) di(meth)acrylate, poly(ethylene glycol) dimethacrylate [sic] (for example, poly(ethylene glycol-600) dimethacrylate, poly(propylene glycol) dimethacrylate [sic] (for example, poly(propylene glycol-400) dimethacrylate), bisphenol A alkoxylate dimethacrylate [sic], in particular bisphenol A ethoxylate and propoxylate dimethacrylate [sic] (for example, bisphenol A 5-ethoxylate dimethacrylate, bisphenol A 4,8-ethoxylate dimethacrylate and bisphenol A 30-ethoxylate dimethacrylate).

Mention may also be made, among the monofunctional monomers (II), of aromatic mono(meth)acrylate oligomers, and, among the trifunctional monomers, of tri(2-hydroxyethyl)iso- cyanurate triacrylate, trimethylolpropane ethoxylate acrylate [sic] and trimethylolpropane propoxylate acrylate [sic].

An important condition of the polymerizable compositions according to the invention is that they result in transparent polymer substrates having a glass transition temperature such that 70° C.≦Tg≦110° C., preferably 80° C.≦Tg≦100° C.

When it is present, the monomer or the monomers (II) must be such that the final polymerizable composition results in substrates having a glass transition temperature which satisfies the above relationship. The monomer or monomers (II), when they are present in the composition according to the invention, generally represent from 20 to 60% by weight of the polymerizable monomers of the composition.

Preferably, when the mean value of \overline{m+n} for the monomers of formula (I) present in the composition according to the invention is less than approximately 4 to 5, the proportion of monomers (II) is generally between 35 and 60% by weight with respect to the total weight of the polymerizable monomers present in the composition and use will be made of monomers (II) having relatively longer chains, while, when the mean value of \overline{m+n} of the monomers (I) is greater than approximately 4 or [sic] 5, the monomer or monomers (II) preferably represent from 20 to 50% by weight of the polymerizable monomers present in the composition and use will be made of monomers having relatively shorter chain lengths.

For monomers of formula (I) for which the mean value is of the order of 4 to 5, use will be made of 0 to 50% by weight of monomers (II).

In addition, when it is desired to obtain a polymerizable composition for the manufacture of optical or ophthalmic articles having photochromic properties, it is desirable for the composition to comprise one or more monomers (II) chosen from the group (A) of long-chain monomers, this group being composed of the following monomers:

—monomers of formula (IIa) in which p can take the values from 10 to 50;

—monomers of formula (IIb) in which Y is an alkylene group comprising 10 to 50 carbon atoms; and

—monomers of formula (IIc) for which \overline{q+r}≧15.

This or these monomers of the group (A) preferably represent 5 to 15% by weight of the copolymerizable monomers of the composition.

It is preferable for these long-chain monomers not to be present at an excessively high concentration because they would lower to an excessively significant degree the value of Tg.

Preferably, in order to obtain photochromic articles, use will be made of a mixture of monomers (II), at least one of which will be chosen from the monomers of the group (A) and at least one other of which will be chosen from the monomers (II) with a chain length lower than those of the monomers of the group (A).

It is remarkable to observe that the polymers obtained from the polymerizable compositions according to the invention are rendered photochromatizable without the addition of specific monomers, such as non- polymerizable plasticizers of the poly(ethylene glycol) dibenzoate type, as disclosed in the document WO-95/10790. This is a particularly attractive advantage of the invention, because such non- polymerizable plasticizers present problems during subsequent treatments of optical glasses (vacuum treatment, and the like), which are thus avoided in the case of the invention.

The compositions according to the invention also comprise a system for initiating the polymerization. The polymerization initiating system can comprise one or more thermal or photochemical polymerization initiating agents or alternatively, preferably, a mixture of thermal and photochemical polymerization initiating agents. These initiating agents are well known in the art and use may be made of any conventional initiating agent. Mention may be made, among the thermal polymerization initiating agents which can be used in the present invention, of peroxides, such as benzoyl peroxide, cyclohexyl peroxydicarbonate and isopropyl peroxydicarbonate.

Mention may be made, among the photoinitiators, of in particular 2,4,6-trimethylbenzoyldiphenyl- phosphine oxide, 1-hydroxycyclohexyl phenyl ketone, 2,2-dimethoxy-1,2-diphenylethane-l-one [sic] and alkyl benzoyl ethers.

Generally, the initiating agents are used in a proportion of 0.01 to 5% by weight with respect to the total weight of the polymerizable monomers present in the composition. As indicated above, the composition more preferably simultaneously comprises a thermal polymerization initiating agent and a photoinitiator.

The polymerizable compositions according to the invention can also comprise additives conventionally used in polymerizable compositions for the moulding of optical or ophthalmic articles, in particular glasses for spectacles and lenses, in conventional proportions, namely inhibitors, colorants, UV absorbers, fragrances, deodorants, antioxidants, anti-yellowing agents and photochromic compounds.

In order to obtain optical or ophthalmic articles having photochromic properties, one or more photochromic compounds can be incorporated by any known means. The photochromic compound or compounds can either be directly incorporated in the pigment form in the polymerizable composition or the photochromic material or materials can be incorporated in the polymer substrate obtained from the polymerizable compositions by a well known process of impregnation and of heat transfer.

Any conventional photochromic compound, such as spirooxazines and chromenes, can be used.

In the following examples, except when otherwise indicated, all the parts and percentages are expressed by weight and the proportions of the additives, other than the polymerizable monomers, are expressed with respect to the total weight of the polymerizable monomers of the composition.

### COMPARATIVE EXAMPLE A and EXAMPLE 1

The polymerizable compositions in Table I below were prepared and these compositions were cast between two flat moulds exhibiting a separation of 2 mm and were then prepolymerized for 3 seconds in an IST batch photopolymerization furnace. The mould was placed vertically between two lamps, the illumination of which was adjusted to 70 milliwatts/cm². These compositions were subsequently polymerized for 10 minutes in a continuous furnace for UV polymerization thermally assisted at 120° C. The moulds were taken apart and the biplanar polymer substrate obtained was annealed for two hours at 60-120° C. The physical properties of the polymer substrates are also shown in Table I below.

TABLE I

| | COMPARATIVE | |
|---|---|---|
| | EXAMPLE | EXAMPLE |
| | A | 1 |
| Polymerizable monomers | | |
| Neopentyl glycol dimethacrylate | 100 | — |
| EBP2PODNA | — | 100 |
| Additives | | |
| Photoinitiator | | |
| CCI 1350 (CIBA) | 0.1% | 0.1% |
| UV absorber | | |
| Cyasorb ® UV 5411 (Cyanamid) | 0.07% | 0.07% |
| Index, n_{d} [sic], 25° C. | 1.4983 | 1.4930 |
| Abbe number | 54 | 55 |
| Density, g/cm³ | 1.18 | 1.07 |
| Shrinkage, % | 11.3 | 8.9 |
| Colour | Pale yellow | Colour- |
| | | less |
| Tg, ° C. | 145 | 109 |
| Water uptake, % | 1.7 | 0.6 |

The polymerized material obtained from the composition according to the invention exhibits a lower density than the material of Comparative Example A.

The composition of Example 1 exhibits superior photochromic properties to those of Comparative Example A.

### COMPARATIVE EXAMPLES B and C and EXAMPLES 2

The polymer substrates were prepared from polymerizable compositions according to the invention as above. The compositions and the properties of the substrates obtained are shown in Table II below.

TABLE II

| | Comparative Example B | Comparative Example C | Example 2 | Example 3 | Example 4 | Example 5 |
|---|---|---|---|---|---|---|
| EBP2PODMA | 0 | 13 | 40 | 49 | 55 | 67 |
| BPA5EODMA | 24 | 22 | 20 | 14 | 18 | 17 |
| PPG400DMA | 76 | 65 | 40 | 37 | 27 | 16 |
| Additives | | | | | | |
| CGI1850 photoinitiator | 0.11 | 0.12 | 0.13 | 0.15 | 0.155 | 0.16 |
| UV5411 UV absorber | 0.07 | 0.07 | 0.07 | 0.07 | 0.07 | 0.07 |
| TPP antioxidant | 0.2 | 0.2 | 0.2 | 0.2 | 0.2 | 0.2 |
| Properties | | | | | | |
| Index, n_{D}, 25° C. | 1.4992 | 1.4993 | 1.5012 | 1.4975 | 1.5015 | 1.5023 |
| Abbe | 58 | 58 | 58 | 58 | 57 | 57 |
| Density, g/cm³ | 1.114 | 1.108 | 1.102 | 1.093 | 1.09 | 1.085 |
| Colourability, Tv red, PS 20/10 | 22 | 29 | 32 | 35 | 40 | 45 |
| Yellowing index, YI, 160/10 | 3.2 | 3.3 | 3.2 | 3.1 | 3.5 | 3.2 |
| Test of exposure to sunlight | OK | OK | OK | OK | OK | OK |
| Transmission, Tv, % | 90.7 | 91 | 91.1 | 92 | 91.5 | 91.5 |
| UV cutoff, nm | 375 | 375 | 375 | 375 | 375 | 375 |
| Water uptake, % | 1.6 | 1.6 | 1.5 | 1.2 | 1.1 | 0.8 |
| Impact, 12/10, −2.00 | OK | OK | OK | OK | OK | OK |
| Test carried out on a glass with | | | | | | |
| a centre thickness of 1.2 mm | | | | | | |
| Tg (maximum tg [sic] δ), ° C. | 50 | 63 | 75 | 90 | 95 | 100 |
| Hardness, MPa, 25° C. | 30 | 62 | 76 | 82 | 95 | 100 |
| Resistance to abrasion (Bayer) | (1.51) | (1.45) | (1.25) | (1.11) | (1.0) | (0.9) |

EBP2PODMA: 2-ethyl-2-butyl-1,3-propanediol 2x-propoxylate dimethacrylate

PPG400DMA: poly(propylene glycol-400) dimethacrylate

BPA5EODMA: Bisphenol A 5-ethoxylate dimethacrylate

TPP: Triphenylphosphine (antioxidant)

Analogous results were obtained with a mixed UV and thermal initiating system. The polymerization process then comprises a prepolymerization by UV radiation (or gelling) of 3 seconds and then a thermal polymerization in an air oven (1 h, 120° C.) and the catalyst used is TBPEH (tert-butyl per(2-ethylethanoate)) provided by the company SPQ.

The compositions 2 to 4 provide an excellent compromise between the various properties. In all cases, the densities of the polymerized substrates obtained are much lower than those of the low index reference material CR39 (1.32) sold by the company PPG Industries.

The polymerized materials obtained from the compositions B and C are deformed during a surface working operation.

### EXAMPLES 6 to 12

The compositions shown in Table III below were prepared and polymerized as above. The properties of the materials are also given in Table III.

TABLE III

| | 6 | 7 | 8 | 9 | 10 | 11 | 12 |
|---|---|---|---|---|---|---|---|
| EBP2PODMA | 80 | 60 | 60 | 60 | 60 | 60 | 60 |
| D101 | | | 30 | | | | |
| PPG400DMA | | 30 | | | 20 | 20 | |
| SR344 | | | | 30 | | | |
| DCPMA | | | | | | | 30 |
| CN131 | 20 | 10 | | | | | 5 |
| SR368 | | | 10 | 10 | | | 5 |
| CD501 | | | | | 20 | | |
| CD502 | | | | | | 20 | |

Additives

| | | | | | | | |
|---|---|---|---|---|---|---|---|
| % CGI1850 | 0.15 | 0.15 | 0.15 | 0.15 | 0.15 | 0.15 | 0.15 |
| % UV5411 | 0.07 | 0.07 | 0.07 | 0.07 | 0.07 | 0.07 | 0.07 |
| % TPP | 0.2 | 0.2 | 0.2 | 0.2 | 0.2 | 0.2 | 0.2 |

Properties

| | | | | | | | |
|---|---|---|---|---|---|---|---|
| Index, n_{c}, 25° C. | 1.504 | 1.49 | 1.52 | 1.49 | 1.49 | 1.49 | 1.49 |
| Abbe | 57 | 58 | 55 | 58 | 57 | 57 | 58 |
| Density, g/cm³ | 1.09 | 1.1 | 1.1 | 1.09 | 1.09 | 1.09 | 1.08 |
| Colourability, | 41.3 | 44 | 39 | 35 | 40 | 35 | 32 |
| Tv red, PS 20/10 | | | | | | | |
| Tg, ° C. | 92 | 80 | 88 | 82 | 91 | 92.5 | 101 |

Monofunctional monomers:

—Aromatic monoacrylate oligomer, CN131, Cray Valley

Difunctional monomers:

—Bisphenol A diethoxylate dimethacrylate, D101, Akzo

—Poly(ethylene glycol-400) diacrylate, SR344, Sartomer

—Dicyclopentadiene [sic] dimethacrylate, DCPMA, Shin Nakamura

Trifunctional monomers:

—Tris(2-hydroxyethyl)isocyanurate triacrylate, SR368, Sartomer

—Trimethylolpropane ethoxylate acrylate [sic], CD502, Sartomer

—Trimethylolpropane propoxylate acrylate [sic], CD501, Sartomer

### COMPARATIVE EXAMPLE D and EXAMPLES 13 to 16

The compositions shown in Table IV below were prepared and polymerized as above.

Photochromic compounds (T4-Gray formulation from the company Transitions Optical) were incorporated in the polymerized substrates obtained by impregnation with two impregnation conditions, namely:

(a) 3 hours at 135° C., and

(b) 6 hours at 140° C.

By way of comparison, a commercially available substrate, CR-407 (aromatic acrylic polymer, n_{D}=1.55, Tg 88° C.), was also impregnated under the conditions (a).

The photochromic kinetics of the impregnated polymerized substrates were determined at a temperature of 30° C.

The substrates were irradiated for 15 minutes, in a thermostatically-controlled cell exposed to the air, with UV radiation of 365 nm, 10 W/m² and 53.4 klux.

The decoloration was carried out in the dark.

The results are given in Table V.

TABLE IV

| | Comparative | | | |
|---|---|---|---|---|
| | Example | Example | Example | Example |
| | D | 13 | 14 | 15 |
| NPG2PODMA | 100 | — | — | — |
| EBP2PODMA | — | 100 | 50 | 50 |
| PPG400DMA | — | — | 10 | 10 |
| BPA4, 8EODMA | — | — | 30 | 30 |
| BPA30EODMA | — | — | 9 | — |
| PEG600DMA | — | — | — | 9 |
| MBOL | — | — | 1 | 1 |
| Initiator, CGI 1850 | 0.15 | 0.15 | 0.15 | 0.15 |
| UV absorber, UV5411 | 0.07 | 0.07 | 0.07 | 0.07 |
| Refractive index, n_{D} | — | — | 1.5 | 1.5 |
| Abbe | — | — | 57 | 58 |
| Tg, ° C. | 119 | 108 | 90 | 86 |

NPG2PODMA: Neopentyl glycol 2x-propoxylate dimethacrylate

PPG400DMA: Poly(propylene glycol-400) dimethacrylate

BPA4,8EODMA: Bisphenol A 4,8-ethoxylate dimethacrylate

BPA30EODMA: Bisphenol A 30-ethoxylate dimethacrylate

PEG600DMA: Poly(ethylene glycol-600) dime thacrylate

MEOL: Methylbutenol (anti-yellowing agent)

TABLE V

| | |
|---|---|
| Transmission, % | Decoloration time |

| | o [sic] | 15 | t 1/2 | t 3/4 |
|---|---|---|---|---|
| | minutes | minutes | [sic] (s) | [sic] (s) |
| Comparative D, (a) | 91.2 | 41.9 | 122 | 662 |
| Comparative D, (b) | 90.4 | 35.9 | 151 | 874 |
| Example 13, (a) | 90.7 | 30.9 | 66 | 324 |
| Example 13, (b) | 90 | 30.8 | 65 | 310 |
| Example 14, (a) | 88.3 | 23.4 | 34 | 116 |
| Example 14, (b) | 87.6 | 25.7 | 35 | 135 |
| Example 15, (a) | 89.2 | 25.5 | 56 | 219 |
| Example 15, (b) | 88 | 24.7 | 59 | 300 |
| CR 407 (a) | 84 | 26 | 34 | 121 |

The composition of Example 14 exhibits photochromic properties superior to or comparable with those of the substrate CR407®.

Another important aspect of the polymerizable compositions according to the invention is that they lend themselves well to the manufacture of optical and ophthalmic articles, such as lenses, by the overmoulding technique. A technique for manufacturing lenses by overmoulding on the front surface of a preform is disclosed, inter alia, in the documents U.S, Pat. No. 5,531,940, U.S, Pat. No. 5,372,755 and U.S, Pat. No. 5,288,221.

The preparation of photochromic articles by overmoulding is set out more particularly in the document U.S, Pat. No. 5,531,940.

Briefly, this overmoulding technique consists in casting a polymerizable composition into an organic glass of optical quality in the space provided between a mould and the front surface of a lens preform made of organic glass of optical quality and in polymerizing the cast composition in order to form a polymerized coating adhere [sic] to the surface of the lens. The lens preform can be finished or semi-finished and the coated surface of the preform can optionally be depolished. It is also possible to carry out the overmoulding on the rear surface of the lens of a preform.

In order to demonstrate the suitability for overmoulding of the compositions according to the invention, photopolymerizable compositions according to the invention and according to the prior art were cast between the rear surface of a lens preform with a thickness of 2 mm made of various organic glasses (including made of an organic glass obtained from a composition according to the invention) and a mould made of an inorganic material. These cast compositions were polymerized by UV irradiation (between two 70 mw/cm² [sic] mercury lamps) for 60 seconds. The products obtained are subsequently removed from the mould and fractured with a hammer. The polymerized layer is regarded as adhering to the preform if the pieces do not exhibit adhesive failure at the interface between the layer and the preform. The compositions are given below and the results summed up in Table VI.

COMPOSITION 1 (according to the invention)

| | |
|---|---|
| EBP2PODMA | 50 |
| PPG 400 DMA | 19 |
| EPA 4, 8 EODMA | 30 |
| MBOL | 1 |
| CGT 1850 | 0.1 |
| UVT 5411 | 0.07 |

COMPOSITION 2 (conventional)

| | |
|---|---|
| Tri (propylene glycol) | 37.4 |
| dimethacrylate (TPGDMA) | |
| PPG 400 DMA | 48.5 |
| D 121 | 14.1 |
| TPP | 0.2 |
| CCI 1850 | 0.10 |

The lens preforms were obtained by casting the chosen composition in a mould and by carrying out a prepolymerization by the photochemical route for 3 seconds under 70 mW/cm² UV, followed by a thermal polymerization at 120° C. for 10 minutes. After removing from the mould, annealing is carried out for 2 hours at 120° C.

TABLE VI

| Lens preform | | | |
|---|---|---|---|
| | Depolished | | |
| Composition | rear face | Overmoulding composition | Adhesion |
| 2 | no | 2 | no |
| 2 | yes | 2 | no |
| 2 | yes | CR39 (di(ethylene glycol) | no |
| | | bis (allyl carbonate) | |
| 2 | yes | BPA polyethoxylate DMA | no |
| 1 | no | 2 | yes |
| 1 | no | 1 | yes |
| 1 | no | BPA polyethoxylate DMA | yes |

TPGDMA: Tri(propylene glycol) dimethacrylate

EBP2PODMA: 2-ethyl-2-butyl-1,3-propanediol 2x-propxylate dimethacrylate

BPA polyethoxylate DMA: Bisphenol A polyethoxylate dimethacrylate (Polymerizable compositions based on these monomers are disclosed in FR-A-2,699,541)

CR39®: Composition based on di(ethylene glycol) bis(allyl carbonate) sold by PPG Industries.

The physical properties of the polymer substrates were determined as indicated below.

The yellowing index was measured according to ASTM Standard D 1925-63.

The Bayer resistance to abrasion was determined according to ASTM Standard F 735-81.

The impact strength was determined according to the United States FDA test (ball drop test) in which a 16 g ball is allowed to fall onto a lens from a height of 1.27 m, corresponding to an energy of 200 mJ.

OK means that the glass is intact after the impact.

The test of exposure to sunlight consists in subjecting the lenses for 200 hours to exposure to sunlight under the same conditions with a Suntest Hanau device emitting radiation of 24.4 w/m² [sic] in the 300-400 nm spectral range and in measuring the yellowing index (YI) before and after irradiation. The test is regarded as positive (OK) if the difference in YI is less than or equal to 1.

Measurement of the colourability

The measurement given is the value of the transmission, measured in the visible, of a glass with a centre thickness of 2 mm coloured by steeping in an aqueous bath at 94° C., in which bath is dispersed a red pigment “Disperse Red 13” from the company Eastman Kodak.

The Tg is measured by DMA (Dynamic mechanical analysis) on a flat test specimen of 5.2 cm×1 cm×2 mm (thickness).

The test is carried out in 3-point bending.

Tg corresponds to the maximum of the ratio

$$\frac{{E}^{″}}{{E}^{′}} \frac{( loss modulus )}{( storage modulus )} .$$

The water uptake test consists in placing a piece of lens in an oven for 12 hours at 50° C. The sample is subsequently weighed (measurement of the starting mass) and then it is immersed in distilled water at 50° C. at atmospheric pressure for 12 hours.

After 12 hours, the sample is removed, wiped dry and weighed (mass after immersion).

The value for the water uptake is given by:

$$Water uptake = \frac{mass after immersion - starting mass}{starting mass} \times 100$$

The hardness values were measured by means of a Fischer micro hardness tester equipped with a Bergovitch tip on a flat lens with a thickness of 1.6 mm.

Generally, except when otherwise indicated, all the tests were carried out on samples with a thickness of 2 mm.

1. Polymerizable monomer composition, characterized in that it comprises, with respect to the total weight of the polymerizable monomers present in the composition:
30 to 100% of one or more monomers (I) of formula: 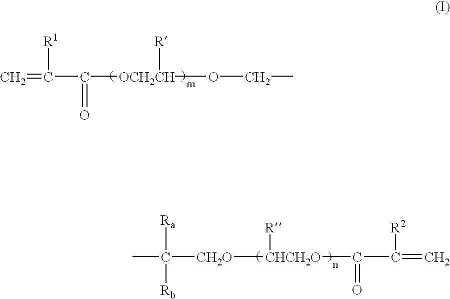
in which R¹, R², R′ and R″ represent, independently of one another, a hydrogen atom or a methyl radical, Rₐ and R_{b}, which are identical or different, each represent an alkyl group having 1 to 10 carbon atoms, provided that Rₐ and R_{b} do not simultaneously represent a methyl group, and m and n are integers satisfying the relationship 2≦m+n≦20;
0 to 70% of at least one other monomer polymerizable (ii) [sic] by a radical route, other than the monomer (i), such that a transparent substrate resulting from the polymerization of the composition has a glass transition temperature satisfying the relationship 70° C.≦tg≦110° C.; and
at least one system for initiating the polymerization:

2. Composition according to claim 1, characterized in that the monomer or monomers (II) comprise one or more (meth)acrylate functional groups and/or one or more allyl groups, preferably two methacrylate functional groups, two allyl groups or one methacrylate functional group and one allyl group.

3. Composition according to claim 1 or 2, characterized in that Rₐ and R_{b} represent a C₂ to C₆ alkyl group, preferably an ethyl, propyl or butyl group.

4. Composition according to any one of claims 1 to 3, characterized in that R¹ and R² are CH₃ groups.

5. Composition according to claim 1, characterized in that the monomer (I) is 2-ethyl-2-n-butyl-1,3-propanediol 2x-propoxylate dimethacrylate.

6. Composition according to any one of claims 1 to 5, characterized in that the monomer(s) (II) is (are) chosen from:
a) monomers of formula
R³-O(R⁵ₚR⁴ (IIa)
in which R³ is a (meth)acryloyl radical, R⁴ is H, a (meth)acryloyl radical or a hydrocarbon-comprising radical having 1 to 40 carbon atoms, R⁵ is a C₁-C₅ alkylene group and p is an integer from 2 to 50;
b) monomers of formula:
R⁶ -Y-R⁷ (IIb)
where R⁶ and R⁷ represent H, an acryloyl group or a (meth)acryloyl group ([sic], at least one of R⁶ or R⁷ being a (meth)acryloyl group, and Y is an alkylene radical having from 2 to 50 carbon atoms;
c) monomers of formula: 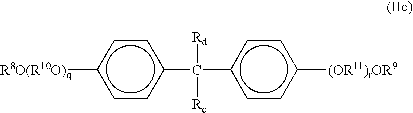
in which R⁸ and R⁹ represent a hydrogen atom, an acryloyl group or a methacryloyl group, provided that at least one of R⁸ or R⁹ is a (meth)acryloyl group, Rd and Re represent H or CH₃, R¹⁰ and R¹¹ represent a C₁-C₅ alkylene group, and q and r are such that \overline{q+r≧}2; and
d) poly(alkylene glycol) di(allyl carbonate) [sic] and monomers comprising a methacrylate functional group and an allyl group.

7. Composition according to claim 6, characterized in that the monomers (IIa) are chosen from poly(methylene glycol) mono- and di(meth)acrylate [sic], poly(ethylene glycol) mono- and di(meth)acrylate [sic], poly(propylene glycol) mono- and di(meth)acrylate [sic], alkoxypoly(methylene glycol) mono- and di(meth)acrylate [sic], alkoxypoly(ethylene glycol) mono- and di(meth)acrylate [sic], alkoxy-poly(propylene glycol) mono- and di(meth)acrylate [sic] and poly(ethylene glycol)-poly(propylene glycol) mono- and di(meth)acrylate [sic].

8. Composition according to claim 6, characterized in that, in the formula (IIc), R_{d} and Rₑ represent CH₃ and R¹⁰ and R¹¹ are ethylene or propylene groups.

9. Composition according to claim 6, characterized in that it comprises one or more monomers (II) chosen from the group (A) of long-chain monomers, this group
(A) being composed:
—of monomers of formula (IIa) in which p can take the values from 10 to 50;
—of monomers of formula (IIb) in which Y is an alkylene group comprising 10 to 50 carbon atoms; and
—of monomers of formula (IIc) for which \overline{q+r}≧15.

10. Composition according to claim 9, characterized in that the monomer or monomers of the group (A) represent 5 to 15% by weight of the copolymerizable monomers of the composition.

11. Composition according to any one of claims 1 to 10, characterized in that the monomer or monomer [sic] (II) are chosen from poly(propylene glycol-400) dimethacrylate, poly(ethylene glycol-600) dimeth-acrylate, bisphenol A diethoxy [sic] dimethacrylate, bisphenol A 5-ethoxylate dimethacrylate, bisphenol A 4,8-ethoxylate dimethacrylate, bisphenol A 30-ethoxylate dimethacrylate, the aromatic monoacrylate oligomer, dicyclopentadiene [sic] dimethacrylate, tri(2-hydroxyethyl)isocyanurate triacrylate, trimethylolpropane ethoxylate acrylate [sic], trimethylolpropane propoxylate acrylate [sic], di(ethylene glycol) di(allyl carbonate) and allyl methacrylate.

12. Composition according to any one of claims 1 to 11, characterized in that the polymerization initiating system comprises one or more thermal initiators, one or more photoinitiators or a mixture of one or more thermal initiators and of one or more photoinitiators.

13. Transparent polymer substrate obtained by polymerization of a composition according to any one of claims 1 to 12.

14. Optical or ophthalmic article comprising a polymer substrate according to claim 13.

15. Optical or ophthalmic article according to claim 13, characterized in that the polymer substrate is overmoulded on a surface of a preform made of transparent organic glass.

16. Optical or ophthalmic article according to either one of claims 14 and 15, characterized in that a photochromic pigment is incorporated in the substrate which constitutes it in all or part.
